(19) United States
(12) Patent Application Publication
(10) Pub. No.: US 2007/0047859 A1
(43) Pub. Date: Mar. 1, 2007

(54) Hydrodynamic bearing type rotary device and recording and reproduction apparatus including the same

(76) Inventors: Takafumi Asada, Osaka (JP); Hiroaki Saito, Ehime (JP); Daisuke Ito, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/491,970

(22) Filed: Jul. 25, 2006

(30) Foreign Application Priority Data
Aug. 31, 2005 (JP) 2005-251043
Feb. 15, 2006 (JP) 2006-37452

(51) Int. Cl. F16C 32/06

(52) U.S. Cl. 384/107

(57) ABSTRACT

A hydrodynamic bearing type rotary device which can maintain an appropriate life by considering the relationship of the life of the bearing with radial load, eccentricity, an oil shearing work function, a rotation rate and the like is provided. A hydrodynamic bearing type rotary device 15 has an shaft being inserted into a bearing hole 1C of a sleeve 1 so as to be relatively rotatable, a hub rotor 7 being attached to one of the sleeve 1 or the shaft 2, which rotates, and a radial bearing surface having hydrodynamic grooves 3A and 3B formed on at least one of an outer peripheral surface of the shaft 2 and an inner peripheral surface of the sleeve 1. Given that an oil shearing work function represented by following Expression (1) is W, the hydrodynamic bearing type rotary device is formed such that a value of 1/W is 10000 or higher:
W=P×L×Ep (1)
Fs=(η×ω×Dˆ2×Lˆ2)/Cˆ3 (2)
Ep=P/(Fs×C) (3)

### TECHNICAL FIELD

The present invention relates to a hydrodynamic bearing type rotary device utilizing a hydrodynamic bearing and a recording and reproduction apparatus including the same.

### BACKGROUND ART

In recent years, recording apparatuses and the like using discs to be rotated experience an increase in a memory capacity and an increase in a transfer rate for data. Thus, bearings used for such recording apparatuses are required to have high performance and high reliability to constantly rotate a disc loading with a high precision. Accordingly, hydrodynamic bearing type rotary devices suitable for high-speed rotation are generally used as such rotary devices.

The hydrodynamic bearing type rotary device includes oil which serves as a lubricant being interposed between an shaft and a sleeve, and generates a pumping pressure by hydrodynamic grooves during rotation. Thus, the shaft can be rotated in a non-contact state with respect to the sleeve. No mechanical friction is generated between the shaft and the sleeve during rotation. Thus, a stable high-speed rotation can be achieved.

Hereinafter, an exemplary conventional hydrodynamic bearing type rotary device will be described with reference to FIG. 11.

As shown in FIG. 11, a conventional hydrodynamic bearing type rotary device includes, a sleeve 21, an shaft 22, a thrust plate 24, oil 25, a base 26, a hub rotor 27, a stator 28 around which coil is wound, and a rotor magnet 29.

The shaft 22 is formed integrally with a flange 23, and is inserted into a bearing hole 21C of the sleeve 21 so as to be rotatable. The flange 23 is accommodated within a recessed portion 21D of the sleeve 21. On at least one of an outer peripheral surface of the shaft 22 and an inner peripheral surface of the sleeve 21, hydrodynamic grooves 21A and 21B are formed. On a surface of the flange 23 which opposes the sleeve 21 and on a surface of the flange 23 which opposes the thrust plate 24, hydrodynamic grooves 23A and 23B are formed. The thrust plate 24 is fixed to the sleeve 21, and a bearing space has a pouch-like shape. Bearing spaces near the hydrodynamic grooves 21A, 21B, 23A, and 23B are filled with at least the oil 25. An entire bearing space having a pouch-like shape which is defined by the sleeve 21 and the shaft 22 is also filled with the oil 25 as necessary.

To the base 26, the sleeve 21 is fixed. The stator 28 is fixed to the base 26 so as to oppose the rotor magnet 29.

The hub rotor 27 is fixed to the shaft 22. To the hub rotor 27, the rotor magnet 29, a or a plurality of disc 30, a spacer 32, a damper 31 and a screw 33 are fixed.

An operation of the conventional hydrodynamic bearing type rotary device having the above-described structure is as described below.

In the conventional hydrodynamic bearing type rotary device, a rotation magnetic filed is generated when an electric current flows through the coil wound around the stator 28. Thus, a rotational force is applied to the rotor magnet 29. The rotor magnet 29 starts rotation with the hub rotor 27, the shaft 22, the flange 23, the disc(s) 30, the spacer 32, the damper 31, and the screw 33. When these members rotate, the hydrodynamic grooves 21A, 21B, 23A, and 23B gather the oil 25 filled in the bearing spaces, and generate pumping pressures between the shaft 22 and the sleeve 21, between the flange 23 and the sleeve 21, and between the flange 23 and the thrust plate 24.

In this way, the shaft 22 can rotate in a non-contact state with respect to the sleeve 21 and the thrust plate 24 and data can be recorded/reproduced on/from the rotating disc 30 by a magnetic head or an optical head, which are not shown.

### DISCLOSURE OF THE INVENTION

(Problems to be Solved by the Invention)

However, the above conventional hydrodynamic bearing type rotary device has following problems.

In the device shown in FIG. 11, between the sleeve 21 and the shaft 22, a minute space of the order of few microns is ensured. Between the flange 23 and the sleeve 21 or the thrust plate 24, a sufficient space of the order of few microns to few tens of microns is ensured. However, when the conventional hydrodynamic bearing type rotary device is rotated continuously at a high speed for a long period of time under high temperature conditions (for example, 70° C.), the oil is affected by a shearing force because of the bearing rotation, and deteriorates. Thus, rubbing may occur or the bearing may seize up in a short period of time.

FIG. 12 shows a result of experiment to continuously rotate a hydrodynamic bearing type rotary device designed for 10000 rpm at a double-speed of 20000 rpm.

This result shows that the life of the hydrodynamic bearing type rotary device is shortened by about 40% compared to that of the device rotated at 10000 rpm.

FIG. 13 shows the result of experiment to continuously rotate a hydrodynamic bearing type rotary device designed to bear a radial bearing load of 110 g with a doubled radial load.

Although no rubbing is observed in the hydrodynamic bearing type rotary device even with the doubled radial bearing load and a non-contact rotation is maintained, the experiment result shows that the life is shortened by about 50%.

As is clear from the experiment results, when the radial hydrodynamic bearing of the conventional hydrodynamic bearing type rotary device is operated with a heavy load for a long period of time under high temperature conditions of about 70° C., the oil deteriorates and the bearing may be broken. Regarding the life of the hydrodynamic bearing type rotary devices, in terms of the relationship between the temperature and the life of the bearing, it has already been proved that as the temperature rises, the life of the bearing shortens in accordance with reaction kinetics by Arrhenius. However, the relationship of the radial load, eccentricity, an oil shearing work function, a rotation rate and the like with the life of the bearing has not yet been made clear theoretically.

An object of the present invention is to provide a hydrodynamic bearing type rotary device which can maintain an appropriate life by considering a relationship of a life of the bearing with a radial load, eccentricity, an oil shearing work function, a rotation rate and the like, and a recording and reproduction apparatus including the same.

(Means for Solving the Problems)

A hydrodynamic bearing type rotary device of the first invention, includes: a sleeve having a bearing hole; an shaft inserted into the bearing hole of the sleeve so as to be relatively rotatable; a hub rotor attached to one of the sleeve and the shaft, which rotates; and a radial bearing surface having hydrodynamic grooves formed on at least one of an outer peripheral surface of the shaft and an inner peripheral surface of the sleeve. Given that an oil (lubricant) shearing work function represented by following Expression (1) is W, the hydrodynamic bearing type rotary device is formed such that a value of 1/W is 10000 or higher:
W=P×L×Ep (1)
Fs=(η×ω×Dˆ2×Lˆ2)/Cˆ3 (2)
Ep=P/(Fs×C) (3)

W: Oil (lubricant) shearing work function

Fs: Stiffness function

Ep: Eccentricity corresponding function

η: Absolute viscosity at 70° C. [N·S/mˆ2]

ω: Angular velocity [rad/S(=2·π·f/60)]

D: Shaft diameter [m]

f: Rotation rate [rev/min]

L: Length of one radial bearing [m]

C: Radial clearance [m]

P: Load applied to a center of the bearing length for each of the radial bearings [N].

In this structure, a lower limit (10000 or higher) is set as a certain condition which has to be satisfied by expressions representing a reciprocal of a shearing work function of a lubricant (hereinafter, referred to as oil shearing work function) such that a hydrodynamic bearing does not receive damage in a short period of time because a lubricant of the hydrodynamic bearing type rotary device (for example, oil and the like: hereinafter, referred to as oil) receives shearing in a high-speed continuous rotation at a high temperature (for example, about 70° C.) and deteriorates, and, thus, the oil tends to evaporate or sufficient oil film strength cannot be obtained.

According to the graph representing the relationship between the reciprocal 1/W of the oil shearing work function W and a ratio of a life of the radial bearing, when the reciprocal 1W of the oil shearing work function W does not exceed 10000, the value set as the lower limit, the oil shearing work function becomes too large, and the ratio of the radial bearing life becomes 15000 or lower. Since the shearing force applied to the oil by rotation of the bearing becomes large, the bearing seizes up due to evaporation of oil or deterioration in oiliness, and the life of the bearing is shortened.

The hydrodynamic bearing type rotary device formed to satisfy the above conditional expressions has an effect to realize a hydrodynamic bearing type rotary device having a long life even when it is continuously rotated at a high-speed under conditions of a high temperature.

A hydrodynamic bearing type rotary device of the second invention is a hydrodynamic bearing type rotary device of the first invention which is formed such that the value of 1/W is 65000 or lower.

In this structure, an upper limit (65000 or lower) is set as a certain condition which has to be satisfied by expressions representing the reciprocal of the shearing work function.

For increasing 1/W, i.e., reducing the oil shearing work function W, a larger bearing space and also the bearing with a larger area are required in order to reduce oil shearing while maintaining the stiffness and the rotation accuracy,. However, in such a device, the viscosity resistance of the oil becomes large at a low temperature, and a current consumption by the motor increases. Further, if bearing space and the area of the bearing are made larger and, at the same time, processed at a high accuracy in order to maintain the bearing stiffness and/or rotation accuracy, the cost for the components becomes high.

Such a structure can prevent excessive quality in terms of the bearing life, and avoid impairing the productivity, the production cost, the performance at the low temperature, or the like.

A hydrodynamic bearing type rotary device of the third invention includes: a sleeve having a bearing hole; an shaft inserted into the bearing hole of the sleeve so as to be relatively rotatable; a hub rotor attached to one of the sleeve and the shaft, which rotates; and a radial bearing surface having hydrodynamic grooves formed on at least one of an outer peripheral surface of the shaft and an inner peripheral surface of the sleeve. Given that an oil (lubricant) shearing corresponding function represented by following Expression (4) is E, the hydrodynamic bearing type rotary device being formed such that a value of 1/E is 0.00001 or higher:
E=Ep×ω×ω (4)
Fs=(η×ω×Dˆ2×Lˆ2)/Cˆ3 (5)
Ep=P/(Fs×C) (6)

E: Oil (lubricant) shearing corresponding function

Fs: Stiffness function

Ep: Eccentricity corresponding function

η: Absolute viscosity at 70° C. [N·S/mˆ2]

ω: Angular velocity [rad/S(=2·π·f/60)]

D: Shaft diameter [m]

f: Rotation rate [rev/min]

L: Length of one radial bearing [m]

C: Radial clearance [m]

P: Load applied to a center of the bearing length for each of the radial bearings [N]

In this structure, a lower limit (0.00001 or higher) is set as a certain condition which has to be satisfied by expressions representing a reciprocal of a shearing corresponding function of the oil such that a hydrodynamic bearing does not receive damage in a short period of time because a lubricant of the hydrodynamic bearing type rotary device (for example, oil and the like: hereinafter, referred to as oil) receives shearing in a high-speed continuous rotation at a high temperature (for example, about 70° C.) and deteriorates, and, thus, the oil tends to evaporate or sufficient oil film strength cannot be obtained.

According to the graph representing the relationship between the reciprocal 1/E of the oil shearing corresponding function E and a ratio of a life of the radial bearing, when the reciprocal 1/E of the oil shearing work function E does not exceed 0.00001, the value set as the lower limit, the oil shearing corresponding function becomes too large, and the ratio of the radial bearing life becomes 15000 or lower. Since the shearing force applied to the oil by rotation of the bearing becomes large, the bearing seizes up due to evaporation of oil or deterioration in oiliness, and the life of the bearing is shortened.

The hydrodynamic bearing type rotary device formed to satisfy the above conditional expressions has an effect to realize a hydrodynamic bearing type rotary device having a long life even when it is continuously rotated at a high-speed under conditions of a high temperature.

A hydrodynamic bearing type rotary device of the fourth invention is a hydrodynamic bearing type rotary device of the third invention which is formed such that the value of 1/E is 0.00013 or lower.

In this structure, an upper limit (0.00013 or lower) is set as a certain condition which has to be satisfied by expressions representing the reciprocal of the shearing corresponding function.

For increasing 1/E, i.e., reducing the oil shearing corresponding function E, a larger bearing space and also the bearing with a larger area are required in order to reduce oil shearing while maintaining the stiffness and the rotation accuracy,. However, in such a device, the viscosity resistance of the oil becomes large at a low temperature, and a current consumption by the motor increases. Further, if bearing space and the area of the bearing are made larger and, at the same time, processed at a high accuracy in order to maintain the bearing stiffness and/or rotation accuracy, the cost for the components becomes high.

Such a structure can prevent excessive quality in terms of the bearing life, and avoid impairing the productivity, the production cost, the performance at the low temperature, or the like.

A hydrodynamic bearing type rotary device of the fifth invention is a hydrodynamic bearing type rotary device of any one of the first through fourth inventions, in which a space in a radial direction formed between the radial bearing surface and the sleeve or the shaft has a width of 1 μm or longer and is substantially uniform.

In this structure, a lower limit is set for the width of the space formed between the radial bearing surface and the sleeve or the shaft.

When the width of the space is below 1 μm, the life of the bearing may be adversely affected depending upon the processing accuracy and surface roughness of the outer peripheral surface of the shaft and/or the inner peripheral surface of the sleeve.

By further satisfying the above condition of 1 μm or longer, always constant life can be maintained irrespective of the processing accuracy and surface roughness of the outer peripheral surface of the shaft and/or the inner peripheral surface of the sleeve.

A hydrodynamic bearing type rotary device of the sixth invention is a hydrodynamic bearing type rotary device of any one of the first through fifth inventions in which a lubricant is held in a space formed between the shaft and the sleeve, and a lubricant reservoir portion is provided adjacent to the radial bearing surface, which has a space from an opposing surface larger than that of the radial bearing surface. A volume of the lubricant reservoir is 10% or more of a volume of a space between the radial bearing surface and the sleeve or the shaft.

In this structure, the size of the volume of the lubricant reservoir portion (hereinafter, referred to as oil sump portion) formed so as to be adjacent to the radial bearing surface is specified by the volume of the space between the radial bearing surface and the sleeve.

Generally, in this type of hydrodynamic bearing type rotary device, an amount of a reservoir of a lubricant such as oil, grease, or the like adjacent to the space formed between the shaft and the sleeve has been ensured for as much as 100% or more compared to the oil amount in the space. In the hydrodynamic bearing type rotary device of the present invention, deterioration of the oil is suppressed by reducing the oil shearing work. Thus, the oil amount of 10% or higher is sufficient for ensuring the reliability of the hydrodynamic bearing type rotary device. In other words, in the hydrodynamic bearing type rotary device of the present invention, the volume of the oil sump portion may be within the range of 10% to 100% that of the space between the radial bearing surface and the sleeve or the shaft, and the hydrodynamic bearing type rotary device with high reliability can be achieved.

By setting the volume of the oil sump portion within the above numerical range with respect to the volume of the space between the radial bearing surface and the sleeve as described above, a hydrodynamic bearing type rotary device which has a long life even when it is rotated continuously at a high-speed under conditions of high temperature.

A recording and reproduction apparatus of the seventh invention includes a hydrodynamic bearing type rotary device of any one of the first through sixth inventions.

With this structure, the life of the recording and reproduction apparatus can be increased while preventing deterioration in performance and quality.

(Effects of the Invention)

According to the hydrodynamic bearing type rotary device of the present invention, a hydrodynamic bearing can be prevented from receiving damage in a short period of time, which it has been receiving because a lubricant such as oil receives shearing and deteriorates, and thus the lubricant such as oil tends to evaporate and the sufficient oil film strength cannot be obtained. Instead, a hydrodynamic bearing type rotary device which has a long life and does not experience insufficiency of an oil film even when it is continuously rotated at a high-speed under conditions of a high temperature can be achieved.

### BRIEF DESCRIPTION OF THE DRAWINGS

FIG. 1 is a cross-sectional view showing a structure of a hydrodynamic bearing type rotary device according to one embodiment of the present invention.

FIG. 2 is a graph showing a relationship between a life of a bearing and oil shearing work function in the hydrodynamic bearing type rotary device.

FIG. 3 is an enlarged view showing a structure near an opening of the hydrodynamic bearing type rotary device of FIG. 1.

FIG. 4 is an enlarged view showing a structure near a radial bearing space of a hydrodynamic bearing type rotary device according to another embodiment of the present invention.

FIG. 5 is a graph showing a relationship between a radial bearing space and the life of the bearing of the hydrodynamic bearing type rotary device.

FIG. 6 is a graph showing a relationship between a ratio of an oil amount in an oil sump and the life of the bearing of the hydrodynamic bearing type rotary device.

FIG. 7 is a graph showing a relationship between a reciprocal of the oil shearing work function and the life of the bearing in the hydrodynamic bearing type rotary device.

FIG. 8 is a graph showing a relationship between a radial friction corresponding function and the oil shearing work function in the hydrodynamic bearing type rotary device.

FIG. 9 is a graph showing a relationship between a stiffness function and the life of the bearing of the hydrodynamic bearing type rotary device.

FIG. 10 is an illustrative diagram showing a center of gravity of the hydrodynamic bearing type rotary device of FIG. 1

FIG. 11 is a cross-sectional view showing a structure of a conventional hydrodynamic bearing type rotary device.

FIG. 12 is a graph showing a relationship between a rotation rate and a life of a bearing in the conventional hydrodynamic bearing type rotary device of FIG. 11.

FIG. 13 is a graph showing a relationship between a radial load and the life of the bearing in the conventional hydrodynamic bearing type rotary device of FIG. 11.

FIG. 14 is a graph showing a relationship between the reciprocal of the oil shearing work function and the life of the bearing in the hydrodynamic bearing type rotary device.

FIG. 15 is a graph showing a relationship between the radial friction corresponding function and an oil shearing corresponding function in the hydrodynamic bearing type rotary device.

FIG. 16 is a graph showing a relationship between the stiffness function and the life of the bearing of the hydrodynamic bearing type rotary device.

FIG. 17 is a graph showing a relationship between an accumulative failure rate of the bearing of the hydrodynamic bearing type rotary device according to the present invention and the time.

FIG. 18 is a schematic block diagram of a recording and reproduction apparatus including a hydrodynamic bearing type rotary device according to the present invention.

### BEST MODE FOR CARRYING OUT THE INVENTION

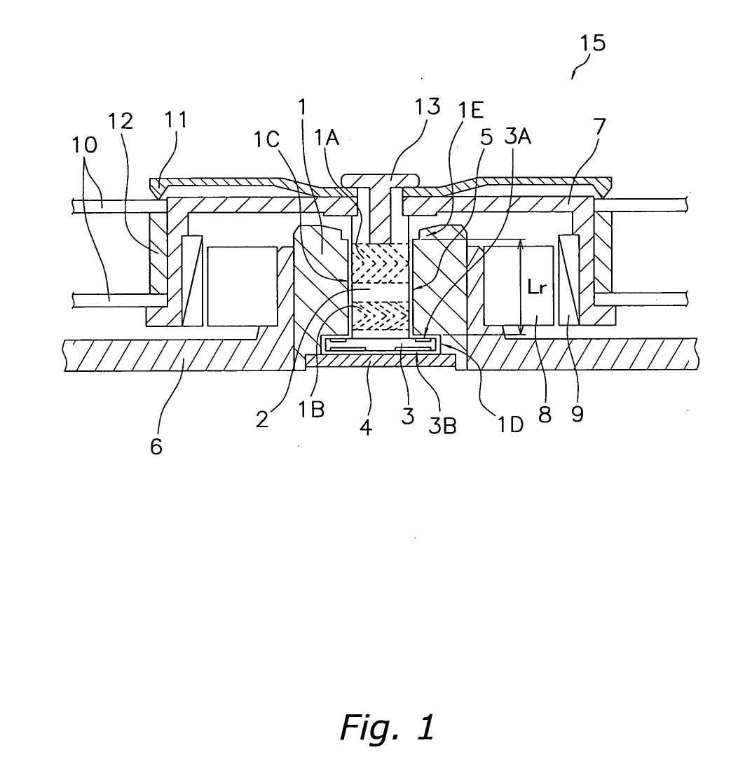

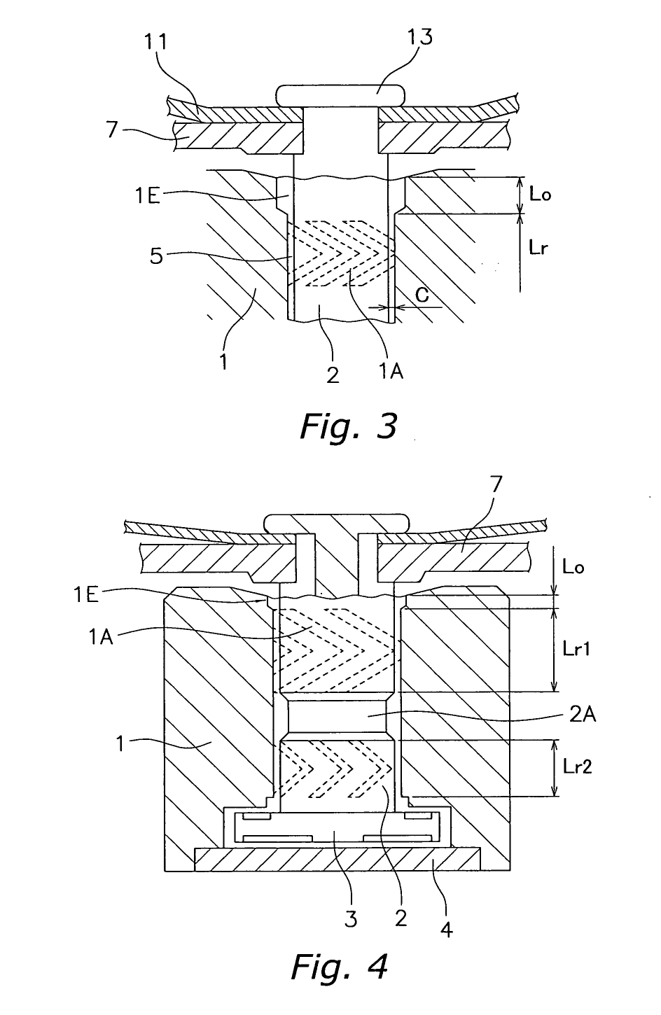

Hereinafter, a hydrodynamic bearing type rotary device 15 according to one embodiment of the present invention will be described with reference to FIGS. 1 and 3.

[Structure of the Hydrodynamic Bearing Type Rotary Device 15]

As shown in FIG. 1, the hydrodynamic bearing type rotary device 15 according to the present embodiment includes a sleeve 1, an shaft 2, a thrust plate 4, oil (lubricant) 5, a base 6, a hub rotor 7, a stator 8 around which coil is wound, and a rotor magnet 9.

The shaft 2 is formed integrally with a flange 3, and is inserted into a bearing hole 1C of the sleeve 1 so as to be rotatable.

The flange 3 is attached to a lower end of the shaft 2 and accommodated within a recessed portion 1D of the sleeve 1.

On at least one of an outer peripheral surface of the shaft 2 and an inner peripheral surface of the sleeve 1, hydrodynamic grooves 1A and 1B are formed. On a surface of the flange 3 which opposes the sleeve 1 and on a surface of the flange 3 which opposes the thrust plate 4, hydrodynamic grooves 3A and 3B are formed.

The thrust plate 4 is fixed to the sleeve 1, and a bearing space has a pouch-like shape.

As shown in FIG. 3, an oil sump (a lubricant reservoir) 1E is formed at an opening of the sleeve 1. The oil sump 1E is provided by making a circumferential groove on the sleeve 1 or the shaft 2.

Bearing spaces near the hydrodynamic grooves 1A, 1B, 3A, and 3B as shown in FIG. 1 are filled with at least the oil 5. An entire bearing space having a pouch-like shape which is defined by the sleeve 1 and the shaft 2 and the oil sump 1E are also filled with the oil 5 as necessary.

The hub rotor 7 is fixed to the shaft 2. To the hub rotor 7, the rotor magnet 9, a or a plurality of discs 10, a spacer 12, a damper 11 and a screw 13 are fixed. To the base 6, the sleeve 1 is fixed. The stator 8 is fixed to the base 6 so as to oppose the rotor magnet 9.

<Operation of the Hydrodynamic Bearing Type Rotary Device 15>

Hereinafter, an operation of the conventional hydrodynamic bearing type rotary device having the above-described structure will be described.

In the hydrodynamic bearing type rotary device 15 according to the present embodiment, a rotation magnetic filed is generated when an electric current flows through the coil wound around the stator 8. Thus, a rotational force is applied to the rotor magnet 9. The rotor magnet 9 starts rotation with the hub rotor 7, the shaft 2, the flange 3, the disc 10, the spacer 12, the damper 11, and the screw 13.

The hydrodynamic grooves 1A, 1B, 3A, and 3B gather the oil 5 filled in the bearing spaces by this rotation, and generate pumping pressures between the shaft 2 and the sleeve 1, between the flange 3 and the sleeve 1, and between the flange 3 and the thrust plate 4.

In this way, the shaft 2 can rotate in a non-contact state with respect to the sleeve 1 and the thrust plate 4, and data can be recorded/reproduced on/from the disc 10 by using a magnetic head or an optical head, which are not shown.

### EXAMPLE 1

Hereinafter, an example of the hydrodynamic bearing type rotary device 15 having the above-described structure will be described with reference to FIGS. 1 through 10.

First, a hypothesis, that a hydrodynamic bearing receives damage in a short period of time when the hydrodynamic bearing type rotary device is operated under conditions that the bearing continuously rotates at a high-speed under a high temperature, is proposed. It is considered that this is because oil filled in bearing spaces deteriorates due to shearing, and deterioration of the oil causes molecules of the oil to be separated, the oil to evaporate, and/or an insufficient film strength to be obtained.

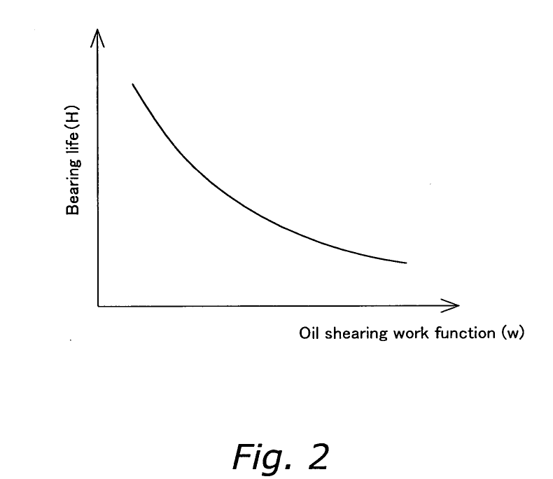

This means it is assumed that the relationship between the oil shearing work function (lubricant shearing work function) and the life of the hydrodynamic bearing will be as represented by a graph shown in FIG. 2. More specifically, it is assumed that, if a shearing work to be applied to the oil in the hydrodynamic bearing type rotary device is set to be within a certain range, the device will have a long life even it is continuously rotated at a high speed under a high temperature.

The first possible means to prevent deterioration due to shearing work by the oil is to reduce an amount of the shearing work to the oil by elucidating a phenomenon of oil shearing and constraining the shearing work not to exceed a certain value. The second possible means is to define a space in a radial direction of the radial bearing, which has a large influence on the oil shearing work function and is affected by a processing accuracy, to be not smaller than a certain value, and to reduce the oil shearing work function and mechanical rubbing. The third possible means is to provide a certain amount (volume) of oil in the oil sump to prevent insufficiency in the oil amount.

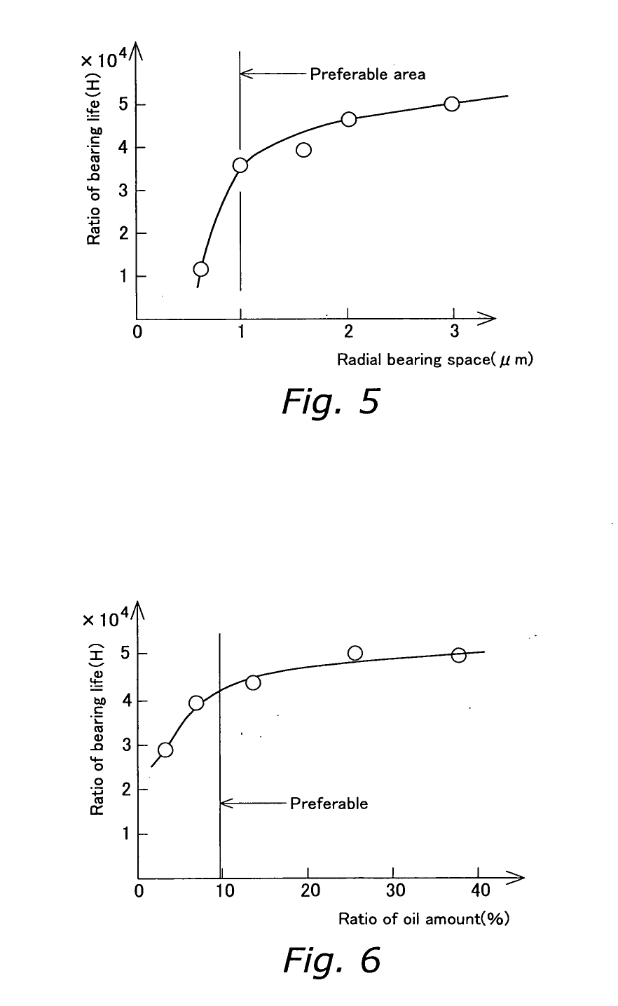

In the present example, in the hydrodynamic bearing type rotary device 15 according to the present embodiment, the width of the radial bearing space between the sleeve 1 and the shaft 2, and a ratio of the actual life of the hydrodynamic bearing (H) have the relationship as represented by the graph shown in FIG. 5.

More specifically, the smaller the space in a radial direction between the radial bearing surface and the sleeve 1 (or the shaft 2), the higher the stiffness of the hydrodynamic bearing. This means that the strength against the external force increases. However, if the width of the space (C) in the radial direction is below 1 μm, the processing accuracy of the outer surface of the shaft 2, the processing accuracy of the inner peripheral surface of the sleeve 1, and/or the surface roughness have adversely effect. Therefore, it is preferable to set the width of the radial bearing space to be 1 μm or longer in order to increase the life of the hydrodynamic bearing type rotary device.

FIGS. 3 and 4 show a structure in which the hydrodynamic grooves 1A are formed in a sufficiently small space defined by the sleeve 1 and the shaft 2, and a substantially straight space with no step is formed between the radial bearing surface and the surface opposing thereto (the sleeve 1 or the shaft 2). FIG. 6 shows a relationship between the ratio of the width of the oil sump section 1E adjacent to the hub rotor 7 (denoted by Lo in the figure) to the width of the space on the hub rotor 7 side (denoted by Lr in the figure) shown in FIG. 4, and the life of the hydrodynamic bearing type rotary device in the above structure.

As can be seen from the graph of FIG. 6, a preferable volume of the oil sump 1E on the hub rotor 7 side is 10% or higher that of the radial bearing space which is substantially straight and is located on the hub rotor 7 side.

When nothing is considered in setting the oil shearing work function and/or the radial bearing space as in the conventional hydrodynamic bearing type rotary device, the amount of oil sump may be required to be 100% or higher in some cases. However, when the setting of the oil shearing work function and/or the radial bearing space is considered as in the present embodiment, the oil does not receive strong shearing. Thus, a small amount of the oil sump as shown in FIG. 6 is sufficient. Since the hydrodynamic bearing type rotary device according to the present embodiment requires a smaller amount of oil compared to the conventional device, the oil can be prevented from spilling even when an impact load is applied to the hydrodynamic bearing type rotary device.

The radial bearing surface shown in FIG. 1 has a one straight portion and a bearing length Lr. However, as shown in FIG. 4, the hydrodynamic grooves 1A and the hydrodynamic grooves 1B may be divided into two by a small diameter portion 2A of the shaft 2 and there may be two straight portions. In such a case, the oil amount shown in FIG. 6 is an oil amount on the radial bearing surface on the hub rotor 7 side (denoted by Lr in the figure).

Next, conditions of the oil shearing work function for constraining the oil shearing work function not to exceed a certain value and for reducing shearing work will be defined by expressions.

Expression 1 represents a hypothesis that the oil shearing work function W is affected by a heating value and a velocity of the radial bearing portion, or is affected by a stiffness of the bearing. Expression 2 represents that the oil shearing work function W is affected by eccentricity of the bearing. Expression 3 represents that the oil shearing work function W is affected by a stiffness function of Expression 2 and an eccentricity corresponding function of Expression 3, respectively.

The numerical expressions are as follows:
Oil shearing work function W=P×L×Ep Expression 1
Eccentricity corresponding function Ep=P/(Fs×C) Expression 2
Stiffness function Fs=(η×ω×Dˆ2Lˆ2)/Cˆ3 Expression 3:

η: Absolute viscosity at 70° C. [N·S/mˆ2]

ω: Angular velocity [rad/s(=2·π·f/60)]

f: Rotation rate [rev/min]

D: Shaft diameter [m]

L: Length of one radial bearing in an axial direction [m]

C: Space of the radial bearing in the radial direction [m]

P: Load applied to a center of the bearing length for each of radial bearings [N]

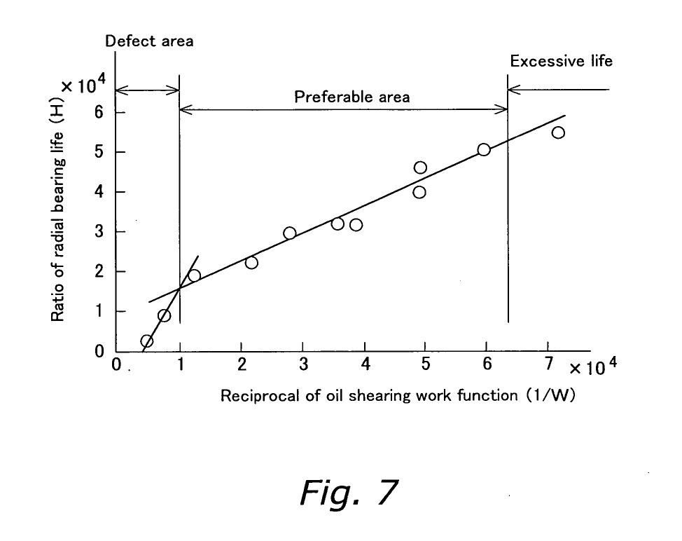

FIG. 7 shows a correlation between a reciprocal (1/W) of the oil shearing work function (W) and actual values of the life of the hydrodynamic bearing type rotary device (H). FIG. 7 shows that the reciprocal (1/W) and the life of the hydrodynamic bearing type rotary device (H) match the experiment results to a significant extent, and it is proved that they have correlation.

Based on the above facts, the hydrodynamic bearing type rotary device in which the oil does not deteriorate due to rotation shearing can be achieved by setting the value of the reciprocal (1/W) of the oil shearing work function (W) to be within the range from 10000 to 65000 as shown in FIG. 7. In view of the life of the bearing, it is preferable to set the value of 1/W as close as possible to 65000 as long as it does not have excessive quality.

The groundings for the lower limit of the above numerical range (10000) is that, when the value of 1/W is smaller than 10000, the oil shearing work function is too large and the life of the bearing is shortened.

More specifically, if 1/W is smaller than the lower limit, 10000, the oil receives a strong shearing force during rotation of the bearing. This causes the oil to evaporate or to lose its oiliness, and the bearing seizes up. The hydrodynamic bearing type rotary device formed to have 1/W not smaller than the lower limit 10000 can bear continuous use of about 50000 hours (corresponding to about 5 years). On the other hand, the hydrodynamic bearing type rotary device having 1/W smaller than 10000 has its bearing seized up in about 3000 to 8000 hours of continuous use. The life is reduced to about 1/10 to ⅕ that of the above structure.

The groundings for the upper limit (65000) is that the value of 1/W larger than 65000 results in an excess life and may impair productivity, cost, performance at a low temperature, or the like.

More specifically, when 1/W is larger than the upper limit, 65000, the life of the device is sufficient. For reducing the oil shearing work function W. i.e., for reducing oil shearing while maintaining the stiffness and the rotation accuracy, the device has to be designed to have a larger bearing space and also the bearing with a larger area. However, in such a device, the viscosity resistance of the oil becomes large at a low temperature, and a current consumption by the motor increases by about 1.2 times to 2.0 times. Such a device does not satisfy the performance demanded for a product. Further, for reducing the oil shearing work function W, if bearing space and the area of the bearing are made larger with the bearing stiffness being maintained, the bearing components of large sizes are processed at a high accuracy and are assembled. Thus, the cost for the components becomes high.

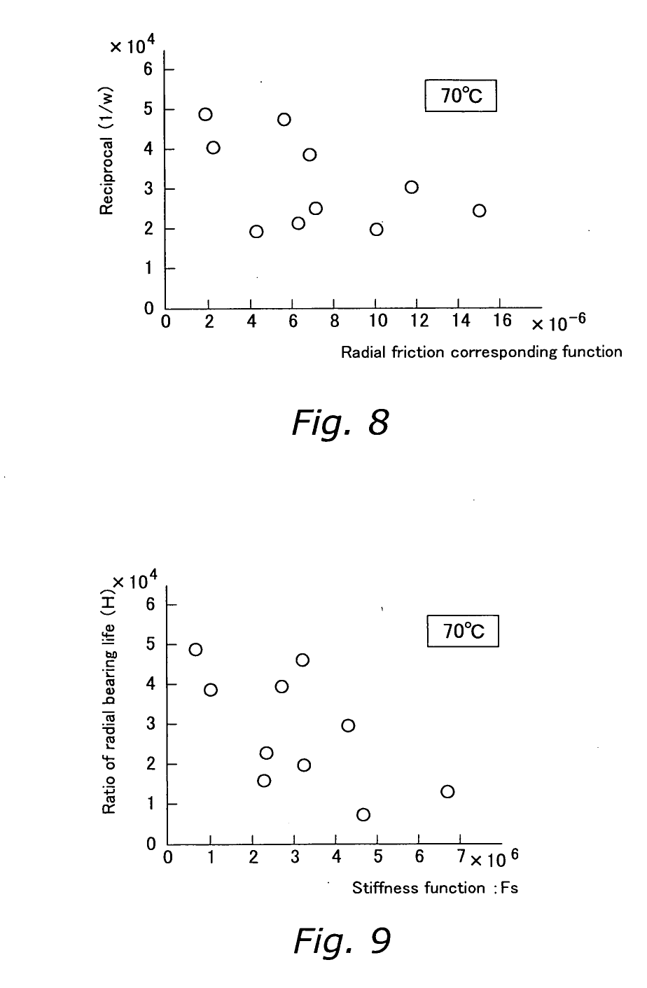

FIG. 8 shows a relationship of a radial friction corresponding function representing a magnitude of friction torque of the radial bearing portion with the reciprocal (1/W) of the oil shearing work function(W). If the reciprocal (1/W) is set too large, the life of the radial bearing becomes longer, but a problem that the radial friction torque becomes large occurs. The radial friction corresponding function is a function proportional to the area of the bearing and the rotation rate and is inversely proportional to the width of the bearing space. However, herein, the function is not described any further.

Next, specific numerical values are used and an actual reciprocal of the oil shearing work function W is calculated.

It is assumed that, in the hydrodynamic bearing type rotary device 15 shown in FIG. 1:

Absolute viscosity at 70° C.: η=0.0041 [N·S/mˆ2];

Angular velocity: ω=565.2 [rad/s(=2×π×5400/60);

Shaft diameter; D=0.000299 [m];

Length of upper radial bearing in an axial direction: L=0.0023 [m];

Space of the radial bearing in the radial direction: C=0.00000309 [m]; and

Load applied to a center of the bearing length of the upper radial bearing: P=0.343 [N].

Based on the above Expressions 1 through 3:
Stiffness function: Fs=(η×ω×Dˆ2Lˆ2)/Cˆ3=3710000;
Eccentricity corresponding function: Ep=P/(Fs×C)=0.0299;
Oil shearing work function: W=P×L×Ep=0.0000236; and
1/W=424000

When this result is plotted to the graph shown in FIG. 7, it is estimated that such a hydrodynamic bearing type rotary device has a sufficient life of about 40000 hours at 70° C.

In the present example, as a material of the shaft 2, a stainless steel, a high manganese chrome steel, or a carbon steel is used. As a material of the sleeve 1, a stainless steel, a copper alloy, or one of these materials coated with electroless nickel plating or DLC coating is used. Further, the materials processed such that the surface roughness of the radial bearing surface is within the range of 0.01 μm to 1.60 μm.

When a copper alloy which is not treated with plating is used for the material of the bearing, the oil and the copper component react chemically and accelerate deterioration. Thus, the life of the hydrodynamic bearing arrangement may be reduced by about 10%. However, the oil shearing work function W defined in the present invention is not taking these parameters into account.

If the values of radial loads applied to the upper and lower radial bearings in the above-mentioned hydrodynamic bearing type rotary device shown in FIG. 4 are unclear, the following method may be used to obtain the values.

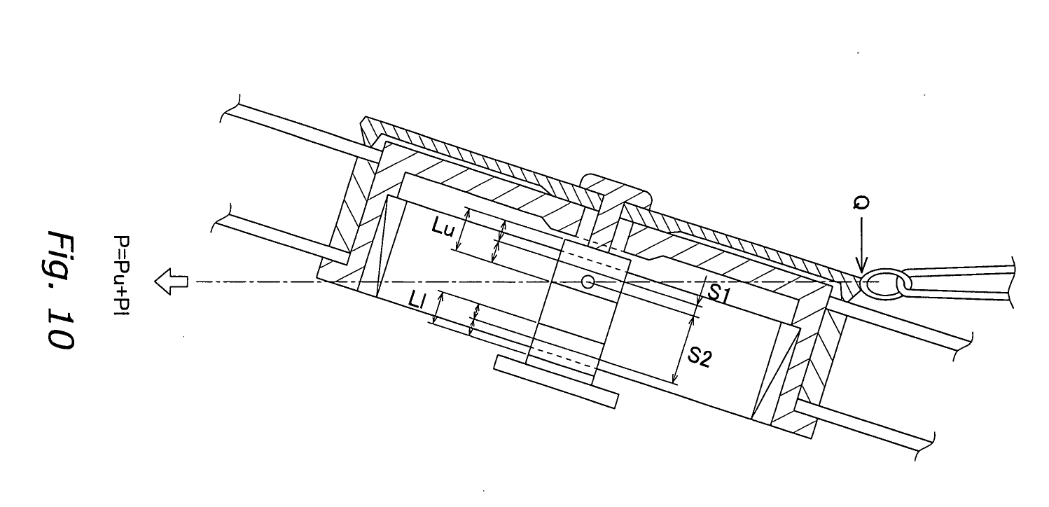

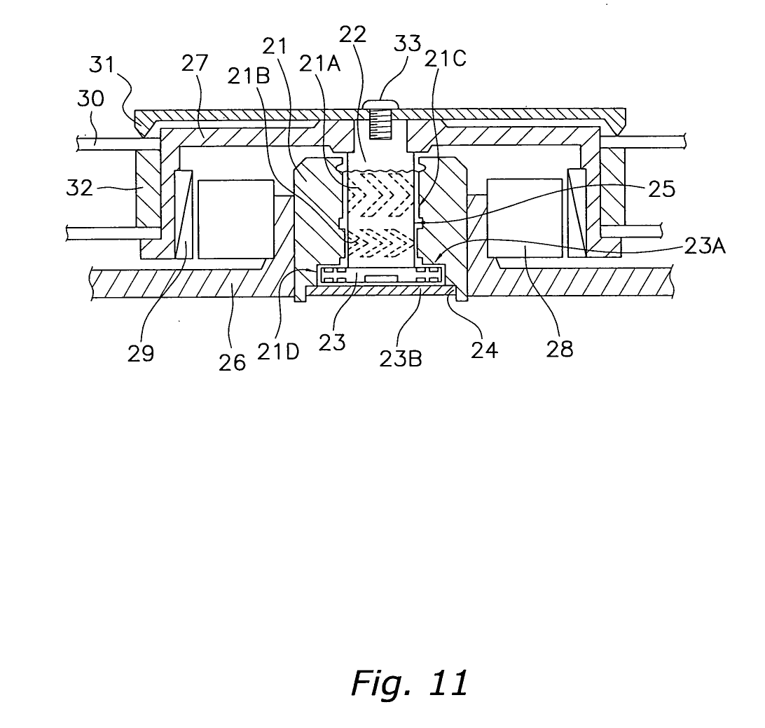

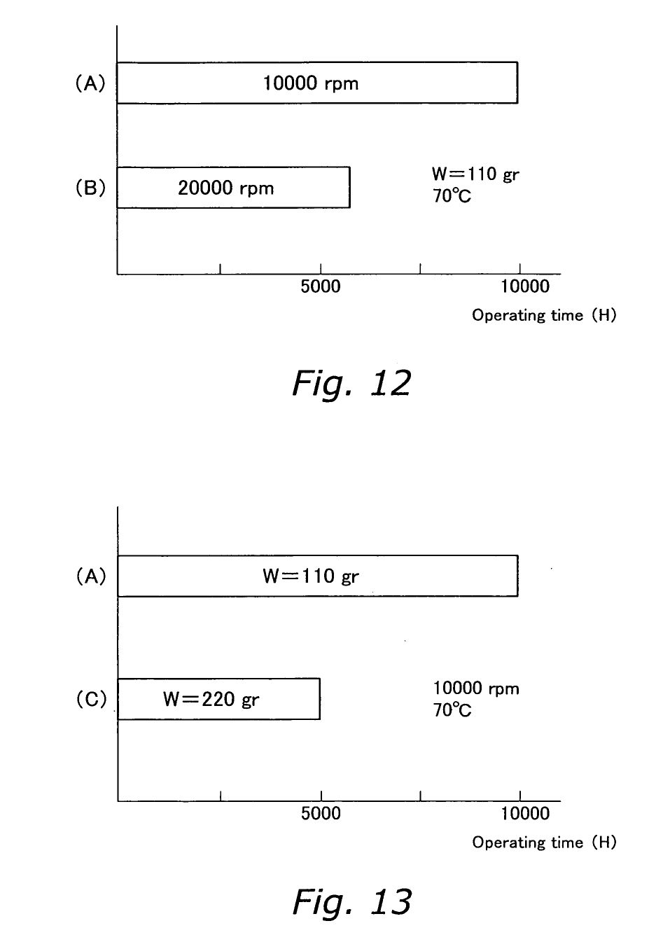

A body of rotation in the hydrodynamic bearing type rotary device of the present invention, i.e., the shaft 2, the flange 3, the hub rotor 7, the rotor magnet 9, the disc(s) 10, the spacer 12, the damper 11 and the screw 13 are removed from device as one component, and a thin thread is attached to an arbitrary position Q. FIG. 10 shows such a structure hung in a natural state. By hanging the portion corresponding to the body of rotation, a center of gravity, which is an intersection of the center of the shaft and an extension of the thread, can be obtained. In general, this method is called a hanging method.

Thus, as shown in FIG. 10, a load Pu applied to a center of the upper bearing length can be obtained based on expression:
Pu=P×(S1/(S1+S2)).

On the other hand, the load Pl applied to a center of the lower bearing length can be obtained based on expression:
Pl=P·Pu.

As described above, by obtaining the position of the center of gravity of a member to be the body of rotation, the values of the radial loads applied to each of the upper and lower radial bearings can be obtained. In this way, even when the hydrodynamic bearing type rotary device has two radial bearing spaces as shown in FIG. 4, P in Expression 1 can be substituted with Pl or Pu to calculate the oil shearing work function W.

As shown in FIG. 9, the stiffness function Fs defined above does not show a strong correlation with the actual length of the radial bearing life H. On the other hand, as shown in FIG. 2, the reciprocal 1/W of the oil shearing work function W has a strong correlation with the bearing life H.

In the present example, the viscosity at a temperature of 70° C. of the oil injected into the space between the shaft and the sleeve affect the life. In the present example, an ester oil is used as a lubricant. When a lubricant including fluorine oil, silicon oil, or olefin oil as a main component is used, there is some change in the life of the hydrodynamic bearing type rotary device. However, it is confirmed by another experiment that the change is about 15% or less. Thus, the oil shearing work function W defined in the present example is not taking these parameters into account. The lubricant may be a highly fluidic grease, or may be an ionic liquid.

As described above, the width of the space in the radial direction on the radial bearing surface is 1.0 μm or longer, and is a substantially straight space with no step which changes the width of the space. The lubricant is filled in the space defined by the shaft and the sleeve. Adjacent to the radial bearing surface, there is the oil sump portion having a space larger than that of the radial bearing surface on the hub rotor 7 side. The oil sump portion is formed to have a volume of 10% or higher that of the space on the radial bearing surface.

As described above, by setting the value of the reciprocal (1/W) of the oil shearing work function (W) of the radial hydrodynamic bearing within the range from 10000 to 65000, the hydrodynamic bearing type rotary device in which the oil does not deteriorate due to rotation searing and which has a long life can be achieved.

### EXAMPLE 2

Hereinafter, another example of the hydrodynamic bearing type rotary device 15 having the above-described structure will be described with reference to FIGS. 1 through 6, 10, and 14 through 17 as in Example 1.

In the present example, the hypothesis is examined using an oil shearing corresponding function (E) instead of the oil shearing work function (W) described in Example 1.

It is assumed that the relationship between the oil shearing corresponding function (E) and the life of the hydrodynamic bearing will be as represented by a graph shown in FIG. 2. More specifically, it is assumed that, if a shearing work to be applied to the oil in the hydrodynamic bearing type rotary device is set to be within a certain range, the device will have a long life even it is continuously rotated at a high speed under a high temperature.

The first possible means to prevent deterioration due to shearing by the oil is to reduce an amount of the shearing to the oil by elucidating a phenomenon of oil shearing and constraining the shearing not to exceed a certain value. The second possible means is to define a space in a radial direction of the radial bearing, which has a large influence on the oil shearing corresponding function and is affected by a processing accuracy, to be not smaller than a certain value, and to reduce the oil shearing work function and mechanical rubbing. The third possible means is to provide a certain amount (volume) of oil in the oil sump to prevent insufficiency in the oil amount.

In the present example, similarly as Example 1, in the hydrodynamic bearing type rotary device 15 according to the present embodiment, the width of the radial bearing space between the sleeve 1 and the shaft 2, and a ratio of the actual life of the hydrodynamic bearing (H) have the relationship as represented by the graph shown in FIG. 5.

More specifically, as described in Example 1, the smaller the space in a radial direction between the radial bearing surface and the sleeve 1 (or the shaft 2), the higher the stiffness of the hydrodynamic bearing. This means that the strength against the external force increases. However, if the width of the space (C) in the radial direction is below 1 μm, the processing accuracy of the outer surface of the shaft 2, the processing accuracy of the inner peripheral surface of the sleeve 1, and/or the surface roughness have adversely effect. Therefore, it is preferable to set the width of the radial bearing space to be 1 μm or longer in order to increase the life of the hydrodynamic bearing type rotary device.

As can be seen from the graph of FIG. 6, described in Example 1, a preferable volume of the oil sump 1E on the hub rotor 7 side is 10% or higher that of the radial bearing space which is substantially straight and is located on the hub rotor 7 side.

When nothing is considered in setting the oil shearing work function and/or the radial bearing space as in the conventional hydrodynamic bearing type rotary device, the amount of oil sump may be required to be 100% or higher in some cases. However, when the setting of the oil shearing work function and/or the radial bearing space is considered as in the present embodiment, the oil does not receive strong shearing. Thus, a small amount of the oil sump as shown in FIG. 6 is sufficient. Since the hydrodynamic bearing type rotary device according to the present embodiment requires a smaller amount of oil compared to the conventional device, the oil can be prevented from spilling even when an impact load is applied to the hydrodynamic bearing type rotary device.

The radial bearing surface shown in FIG. 1 has a one straight portion and a bearing length Lr. However, as shown in FIG. 4, the hydrodynamic grooves 1A and the hydrodynamic grooves 1B may be divided into two by a small diameter portion 2A of the shaft 2 and there may be two straight portions. In such a case, the oil amount shown in FIG. 6 is an oil amount on the radial bearing surface on the hub rotor 7 side (denoted by Lr in the figure) as in Example 1.

Next, conditions of the oil shearing corresponding function for constraining the oil shearing corresponding function not to exceed a certain value and for reducing shearing will be defined by expressions.

Expression 4 represents a hypothesis that the oil shearing corresponding function E is affected by eccentricity and a velocity of the radial bearing portion. Expression 5 represents that the oil shearing corresponding function E is affected by a stiffness or a heating value of the bearing. Expression 6 represents that the oil shearing corresponding function E is affected by shearing or a heating value of the oil.

The numerical expressions are as follows:
Oil shearing corresponding function E=EP×ω×ω Expression 4
Eccentricity corresponding function Ep=P/(Fs×C) Expression 5
Stiffness function Fs=(η×ω×Dˆ2Lˆ2)/Cˆ3 Expression 6

η: Absolute viscosity at 70° C. [N·S/mˆ2]

ω: Angular velocity [rad/s(=2·π·f/60)]

f: Rotation rate [rev/min]

D: Shaft diameter [m]

L: Length of one radial bearing in an axial direction [m]

C: Space of the radial bearing in the radial direction [m]

P: Load applied to a center of the bearing length for each of radial bearings [N]

FIG. 14 shows a correlation between a reciprocal (1/E) of the oil shearing corresponding function (E) and actual values of the life of the hydrodynamic bearing type rotary device (H). FIG. 14 shows that the reciprocal (1/E) and the life of the hydrodynamic bearing type rotary device (H) match the experiment results to a significant extent, and it is proved that they have correlation.

Based on the above facts, the hydrodynamic bearing type rotary device in which the oil does not deteriorate due to rotation shearing can be achieved by setting the value of the reciprocal (1/E) of the oil shearing corresponding function (E) to be 0.00001 or higher as shown in FIG. 14. In view of the life of the bearing, it is preferable to set the value of 1/E as close as possible to 0.00013 or lower as long as it does not have excessive quality.

The groundings for the lower limit of the above numerical range (0.00001) of 1/E is that, when the value of 1/E is smaller than 0.00001, the oil shearing corresponding function is too large and the life of the bearing is shortened.

More specifically, if 1/E is smaller than the lower limit, 0.00001, the oil receives a strong shearing force during rotation of the bearing. This causes the oil to evaporate or to lose its oiliness, and the bearing seizes up. The hydrodynamic bearing type rotary device formed to have 1/E not smaller than the lower limit 0.00001 can bear continuous use of about 50000 hours (corresponding to about 5 years). On the other hand, the hydrodynamic bearing type rotary device having 1/E smaller than 0.00001 has its bearing seized up in about 3000 to 8000 hours of continuous use. The life is reduced to about 1/10 to ⅕ that of the above structure.

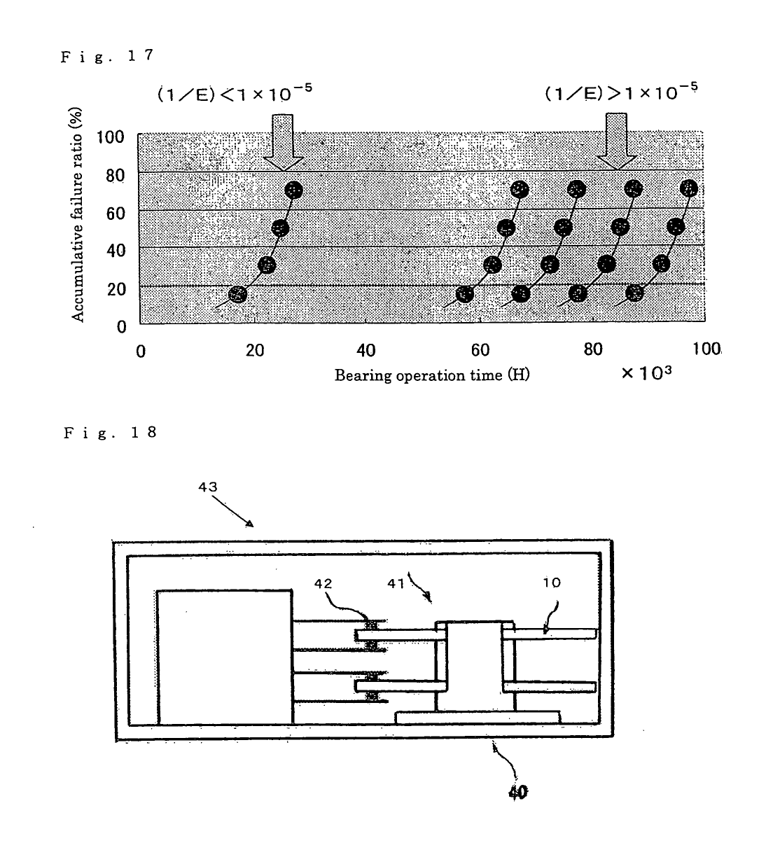

As shown in FIG. 14, the value of the 1/E rapidly changes at 0.00001 and below. It is estimated that, under such conditions, shearing applied to the oil is too large, and the molecular structure of the oil receives stress above tolerance, causing the oil to deteriorate in a short period of time. FIG. 17 shows data of accumulative failure rate collected in the actual experimentation on the life of the bearings. A vertical shaft in FIG. 17 represents the accumulative failure rate of the hydrodynamic bearing type rotary devices, and a horizontal shaft represents the total time of rotation (H). FIG. 17 also shows that a graph for the 1/E value not exceeding 0.00001 is on the left hand side of the figure significantly distant (discontinuously) from other graphs. Based on such data, it is found that the life of the hydrodynamic bearing type rotary device changes when the value of 1/E is 0.00001.

The groundings for the upper limit (0.00013) is that the value of 1/E larger than 0.00013 results in an excess life and may impair productivity, cost, performance at a low temperature, or the like.

More specifically, when 1/E is larger than the upper limit, 0.00013, the life of the device is sufficient. For reducing the oil shearing corresponding function E, i.e., for reducing oil shearing while maintaining the stiffness and the rotation accuracy, the device has to be designed to have a larger bearing space and also the bearing with a larger area. However, in such a device, the viscosity resistance of the oil becomes large at a low temperature, and a current consumption by the motor increases by about 1.2 times to 2.0 times. Such a device does not satisfy the performance demanded for a product.

More specifically, in the hydrodynamic bearing type rotary device, an electric current is supplied to the stator 8 by an LSI (integrated circuit) for driving, which is not shown, and a rotational magnetic field is generated to apply a rotational force to the rotor magnet 9. However, when 1/E is larger than 0.00013, the LSI for driving (not shown) cannot handle with its capacity and fails to supply an electric current to the stator 8. Thus, sometimes, a normal rotation rate cannot be obtained.

Further, for reducing the oil shearing corresponding function E, if bearing space and the area of the bearing are made larger with the bearing stiffness being maintained, the bearing components of large sizes are processed at a high accuracy and are assembled. Thus, the cost for the components becomes high.

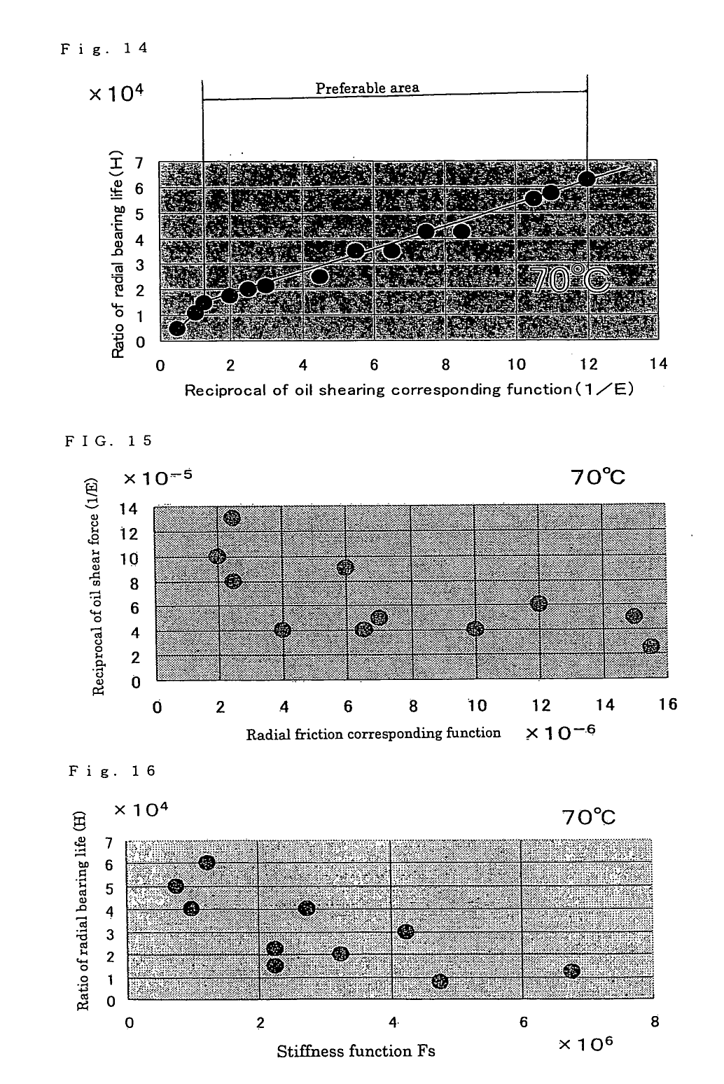

FIG. 15 shows a relationship of a radial friction corresponding function representing a magnitude of friction torque of the radial bearing portion with the reciprocal (1/E) of the oil shearing corresponding function(E). If the reciprocal (1/E) is set too large, the life of the radial bearing becomes longer, but a problem that the radial friction torque becomes large occurs. The radial friction corresponding function is a function proportional to the area of the bearing and the rotation rate and is inversely proportional to the width of the bearing space. However, herein, the function is not described any further.

Next, specific numerical values are used and an actual reciprocal of the oil shearing corresponding function E is calculated.

It is assumed that, in the hydrodynamic bearing type rotary device 15 shown in FIG. 1:

Absolute viscosity at 70° C.: η=0.0035 [N·S/mˆ2];

Angular velocity: ω=439.6 [rad/s(=2×π×4200/60);

Shaft diameter; D=0.000299 [m];

Length of one radial bearing: L=0.00115 [m];

Space of the radial bearing in the radial direction: C=0.00000309 [m]; and

Load applied to a center of the bearing length of the upper radial bearing: P=0.196 [N].

Based on the above Expressions 4 through 6:
Stiffness function: Fs=(η×ω×Dˆ2×Lˆ2)/Cˆ3=616000;
Eccentricity corresponding function: Ep=P/(Fs×C)=0.103;
Oil shearing corresponding function: E=P×L×Ep=19900; and 1/E=0.00005

When this result is plotted to the graph shown in FIG. 14, it is estimated that such a hydrodynamic bearing type rotary device has a sufficient life of about 40000 hours at 70° C.

In the present example, similarly to Example 1, as a material of the shaft 2, a stainless steel, a high manganese chrome steel, or a carbon steel is used. As a material of the sleeve 1, a stainless steel, a copper alloy, or one of these materials coated with electroless nickel plating or DLC coating is used. Further, the materials processed such that the surface roughness of the radial bearing surface is within the range of 0.01 μm to 1.60 μm.

When a copper alloy which is not treated with plating is used for the material of the bearing, the oil and the copper component react chemically and accelerate deterioration. Thus, the life of the hydrodynamic bearing arrangement may be reduced by about 10%. However, the oil shearing corresponding function E defined in the present invention is not taking these parameters into account.

If the values of radial loads applied to the upper and lower radial bearings in the above-mentioned hydrodynamic bearing type rotary device shown in FIG. 4 are unclear, the following method may be used to obtain the values.

A body of rotation in the hydrodynamic bearing type rotary device of the present invention, i.e., the shaft 2, the flange 3, the hub rotor 7, the rotor magnet 9, the disc(s) 10, the spacer 12, the damper 11 and the screw 13 are removed from device as one component, and a thin thread is attached to an arbitrary position Q. FIG. 10 shows such a structure hung in a natural state. By hanging the portion corresponding to the body of rotation, a center of gravity, which is an intersection of the center of the shaft and an extension of the thread, can be obtained. In general, this method is called a hanging method.

Thus, as shown in FIG. 10, a load Pu applied to a center of the upper bearing length can be obtained based on expression:
Pu=P×(S1/(S1+S2)).

On the other hand, the load Pl applied to a center of the lower bearing length can be obtained based on expression:
Pl=P·Pu.

As described above, by obtaining the position of the center of gravity of a member to be the body of rotation, the values of the radial loads applied to each of the upper and lower radial bearings can be obtained. In this way, even when the hydrodynamic bearing type rotary device has two radial bearing spaces as shown in FIG. 4, P in Expression 4 can be substituted with Pl or Pu to calculate the oil shearing corresponding function E.

As shown in FIG. 16, the stiffness function Fs defined above does not show a strong correlation with the actual length of the radial bearing life H. On the other hand, as shown in FIG. 2, the reciprocal 1/E of the oil shearing work function E has a strong correlation with the bearing life H.

In the present example, the viscosity at a temperature of 70° C. of the oil injected into the space between the shaft and the sleeve affect the life. In the present example, an ester oil is used as a lubricant. When a lubricant including fluorine oil, silicon oil, or olefin oil as a main component is used, there is some change in the life of the hydrodynamic bearing type rotary device. However, it is confirmed by another experiment that the change is about 15% or less. Thus, the oil shearing corresponding function E defined in the present example is not taking these parameters into account. The lubricant may be a highly fluidic grease, or may be an ionic liquid.

As described above, the width of the space in the radial direction on the radial bearing surface is 1.0 μm or longer, and is a substantially straight space with no step which changes the width of the space. The lubricant is filled in the space defined by the shaft and the sleeve. Adjacent to the radial bearing surface, there is the oil sump portion having a space larger than that of the radial bearing surface on the hub rotor 7 side. The oil sump portion is formed to have a volume of 10% or higher that of the space on the radial bearing surface.

As described above, by setting the value of the reciprocal (1/E) of the oil shearing corresponding function (E) of the radial hydrodynamic bearing within the range from 0.00001 to 0.00013, the hydrodynamic bearing type rotary device in which the oil does not deteriorate due to rotation searing and which has a long life can be achieved.

[Other Embodiments]

One embodiment of the present invention has been described above. However, the present invention is not limited to the above embodiment, and various modification can be made without departing from the scope of the invention.

(A)

In the above embodiment and examples, an exemplary structure of the bearing in which the shaft 2 rotates and the sleeve 1 is sealed to have a pouch-like shape has been described. However, the present invention is not limited to such an example.

For example, the present invention is also applicable to a hydrodynamic bearing rotary device having both ends of an shaft being fixed and a sleeve being rotatable as shown in FIG. 1 of U.S. Pat. No. 5,112,142 (HYDRODYNAMIC BEARING).

Any type of hydrodynamic bearing rotary device can be used as long as it has a substantially straight bearing space with no step, which corresponds to Lr in FIGS. 1 and 4 in the above embodiment, and has an oil sump connected to either an upper portion or a lower portion of oil on a radial bearing surface.

(B)

In the above embodiment and examples, an exemplary structure of the bearing in which the shaft 2 rotates and the sleeve 1 is sealed to have a pouch-like shape has been described. However, the present invention is not limited to such an example.

For example, the present invention is also applicable to a bearing rotary device having a hub rotor fixed to an upper portion of an shaft and a ring-like member attached to a lower portion of the shaft, in which a circumference of the ring-like member has an oil sump adjacent to the radial bearing surface, and a lower surface of the hub rotor and an upper surface of the sleeve oppose each other to form a thrust bearing surface, the device having chamfers of the sleeve on the corner portions of the hub rotor and the shaft, and an oil sump adjacent to the radial bearing surface on the inner side of the thrust bearing surface as shown in FIG. 2 of Japanese Patent Gazette No. 3155529 (“MOTOR INCLUDING FLUID DYNAMIC BEARING AND A RECORDING DISC DRIVING DEVICE INCLUDING THE MOTOR”).

(C)

In the above embodiment and examples, an exemplary structure of the bearing in which the oil sump is provided around the shaft 2 in the upper portion of the radial bearing surface and an oil sump extending upward in the axial direction is provided on the corner portions of the shaft 2 and the flange 3 in the lower portion of the radial bearing surface has been described. However, the present invention is not limited to such an example.

For example, the present invention is also applicable to a hydrodynamic bearing rotary device having an oil sump extending substantially perpendicular to the shaft provided in the upper portion of the radial bearing surface as described in Japanese Laid-Open Publication No. 2004-36892.

Further, the present invention is similarly applicable to a hydrodynamic bearing type rotary device having a circulating hole on a radial bearing surface as described in Japanese Laid-Open Publication No. 57-137820.

(D)

In the above Example 1, the relationship between the oil shearing work function W of the radial bearing and the hydrodynamic bearing life H has been described. However, the present invention is not limited to such an example.

For example, it may also be possible to explain a thrust bearing portion by establishing similar hypothesis and theory.

(E)

In the above Example 2, the relationship between the oil shearing corresponding function E of the radial bearing and the hydrodynamic bearing life H has been described. However, the present invention is not limited to such an example.

For example, it may also be possible to explain about a thrust bearing portion by establishing similar hypothesis and theory.

(F)

In the above embodiment, an example in which the present invention is applied to a hydrodynamic bearing type rotary device has been described. However, the present invention is not limited to such an example.

For example, as shown in FIG. 18, the present invention is also applicable to a recording and reproduction apparatus 43 which has a hydrodynamic bearing mechanism 40 having the above-described structure and a hydrodynamic bearing type rotary device 41, and which reproduces information recorded on a recording disc 10 or records information on a recording disc 10 by a recording head 42.

In this way, a recording and reproduction apparatus with high reliability can be obtained without impairing performance or quality.

### INDUSTRIAL APPLICABILITY

According to the present invention, a hydrodynamic bearing type rotary device in which oil does not deteriorate due to rotation shearing and which has a long life can be obtained. The present invention is applicable to a wide variety of the hydrodynamic bearing type rotary devices to be incorporated into disc type recording and reproduction apparatuss and the like.

1. A hydrodynamic bearing type rotary device, comprising:
a sleeve having a bearing hole;
an shaft inserted into the bearing hole of the sleeve so as to be relatively rotatable;
a hub rotor attached to one of the sleeve and the shaft, which rotates; and
a radial bearing surface having hydrodynamic grooves formed on at least one of an outer peripheral surface of the shaft and an inner peripheral surface of the sleeve,
given that an oil (lubricant) shearing work function represented by following Expression (1) is W, the hydrodynamic bearing type rotary device being formed such that a value of 1/W is 10000 or higher:
W=P×L×Ep (1)
Fs=(η×ω×Dˆ2Lˆ2)/Cˆ3 (2)
Ep=P/(Fs×C) (3)
W: Oil (lubricant) shearing work function
Fs: Stiffness function
Ep: Eccentricity corresponding function
η: Absolute viscosity at 70° C. [N·S/mˆ2]
ω: Angular velocity [rad/S(=2·π·f/60)]
D: Shaft diameter [m]
f: Rotation rate [rev/min]
L: Length of one radial bearing [m]
C: Radial clearance [m]
P: Load applied to a center of the bearing length for each of the radial bearings [N].

2. A hydrodynamic bearing type rotary device according to claim 1, which is formed such that the value of 1/W is 65000 or lower.

3. A hydrodynamic bearing type rotary device, comprising:
a sleeve having a bearing hole;
an shaft inserted into the bearing hole of the sleeve so as to be relatively rotatable;
a hub rotor attached to one of the sleeve and the shaft, which rotates; and
a radial bearing surface having hydrodynamic grooves formed on at least one of an outer peripheral surface of the shaft and an inner peripheral surface of the sleeve, given that an oil (lubricant) shearing corresponding function represented by following Expression (4) is E, the hydrodynamic bearing type rotary device being formed such that a value of 1/E is 0.00001 or higher:
E=Ep×ω×ω (4)
Fs=(η×ω×Dˆ2×Lˆ2)/Cˆ3 (5)
Ep=P/(Fs×C) (6)
E: Oil (lubricant) shearing corresponding function
Fs: Stiffness function
Ep: Eccentricity corresponding function
η: Absolute viscosity at 70° C. [N·S/Mˆ2]
ω: Angular velocity [rad/S(=2·π·f/60)]
D: Shaft diameter [m]
f: Rotation rate [rev/min]
L: Length of one radial bearing [m]
C: Radial clearance [m]
P: Load applied to a center of the bearing length for each of the radial bearings [N].

4. A hydrodynamic bearing type rotary device according to claim 3, which is formed such that the value of 1/E is 0.00013 or lower.

5. A hydrodynamic bearing type rotary device according to claim 1, wherein:
a space in a radial direction formed between the radial bearing surface and the sleeve or the shaft has a width of 1 μm or longer and is substantially uniform.

6. A hydrodynamic bearing type rotary device according to claim 1, wherein:
a lubricant is held in a space formed between the shaft and the sleeve, and a lubricant reservoir portion is provided adjacent to the radial bearing surface, which has a space from an opposing surface larger than that of the radial bearing surface; and
a volume of the lubricant reservoir is 10% or more of a volume of a space between the radial bearing surface and the sleeve or the shaft.

7. A recording and reproduction apparatus comprising a hydrodynamic bearing type rotary device according to claim 1.

8. A hydrodynamic bearing type rotary device according to claim 3, wherein:
a space in a radial direction formed between the radial bearing surface and the sleeve or the shaft has a width of 1 μm or longer and is substantially uniform.

9. A hydrodynamic bearing type rotary device according to claim 3, wherein:
a lubricant is held in a space formed between the shaft and the sleeve, and a lubricant reservoir portion is provided adjacent to the radial bearing surface, which has a space from an opposing surface larger than that of the radial bearing surface; and
a volume of the lubricant reservoir is 10% or more of a volume of a space between the radial bearing surface and the sleeve or the shaft.

10. A recording and reproduction apparatus comprising a hydrodynamic bearing type rotary device according to claim 3.
